(19) United States
(12) Patent Application Publication
(10) Pub. No.: US 2025/0102188 A1
(43) Pub. Date: Mar. 27, 2025

(54) Load Balanced Solar Thermal System

(71) Applicant: Exowatt, Inc., Miami, FL (US)

(72) Inventors: Hannan PARVIZIAN, Miami, FL (US); Sushrut BAPAT, Miami, FL (US)

(21) Appl. No.: 18/900,313

(22) Filed: Sep. 27, 2024

Related U.S. Application Data
(60) Provisional application No. 63/585,824, filed on Sep. 27, 2023.

(51) Int. Cl. F24S 20/40

(52) U.S. Cl. CPC F24S 20/40

(57) ABSTRACT

A grid-balancing solar-thermal system contains a conventional solar-thermal system coupled with electric heaters that draw excess electric power from the grid or other electrical supply point. A thermal storage stores the excess electricity converted to heat.

### CROSS-REFERENCE TO RELATED APPLICATIONS

Benefit is claimed from U.S. patent application No. 63/585,824 filed Sep. 27, 2023, incorporated by reference in its entirety as if expressly set forth.

This application is related to application No. 63/692,681 filed Sep. 9, 2024, incorporated herein by reference.

### FIELD

The technology herein relates to collection of thermal energy, and to solar collectors that collect solar energy and produce electrical and/or thermal output power. More particularly, the technology relates to a solar thermal system that provides load balancing of the electrical power grid.

### BACKGROUND & SUMMARY

A significant problem with solar thermal collection systems relates to the intermittent nature of their power production capabilities. In particular, solar thermal collection systems are generally able to produce heat only when the sun is in the sky. No power is produced after dark and before dawn, during rainy and snowy weather, when the sky is overcast with clouds, and during other times.

This generally means thermal loads powered by the solar thermal collection system need to rely on some other heat source (e.g., heat generated from electricity) during times when the solar thermal collection system is not producing thermal energy. This can cause significant loading on the electric power grid during times when energy demand is high and solar thermal collection is not possible, driving up energy costs.

### BRIEF DESCRIPTION OF THE DRAWINGS

FIGS. 1 and 2 show a first Load Balancing Solar-Thermal System.

FIGS. 3 and 4 show a second Load Balancing Solar-Thermal System.

### DETAILED DESCRIPTION OF NON-LIMITING EMBODIMENTS

Example embodiments herein provide a heat exchanger that generates and stores heat from the electric power grid to supplement heat collected from the sun. In one example embodiment, the system converts to heat for use and/or storage, excess electricity produced by or available on the power grid when demand is low and electricity is thus less expensive.

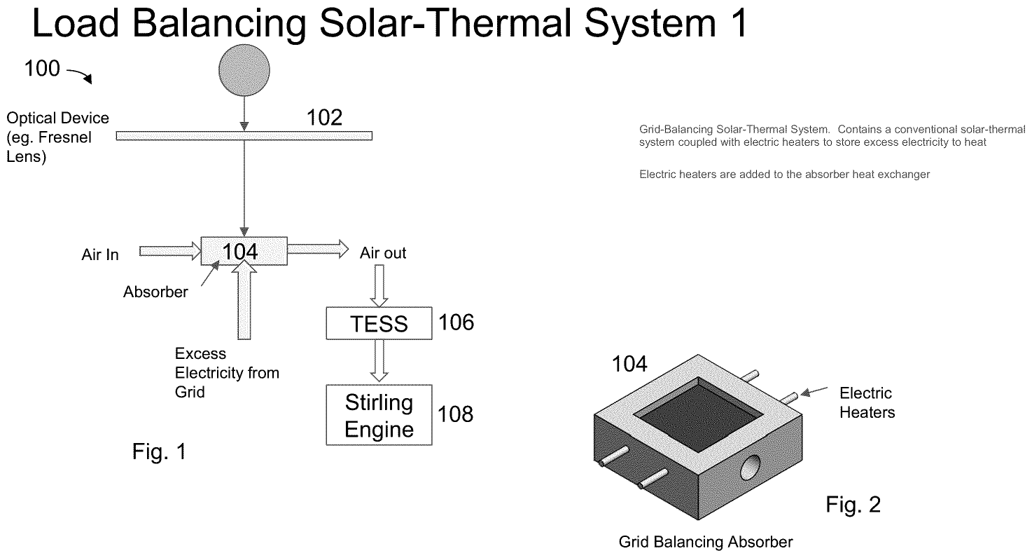

FIG. 1 shows an example solar thermal collection system 100 including an optical device 102 such as a Fresnel lens that collects thermal energy from the sun and focuses the collected thermal energy onto an absorber 104. A circulation system (which can use air or some other gaseous or liquid medium for heat transport) circulates the collected heat from the absorber to a thermal storage system (TESS) 106. The TESS supplies the stored heat to a load such as a thermal engine 108.

In the example shown, the absorber 104 has electric heating elements that are selectively connected to and disconnected from the electric power grid or other source of electric power. During periods when the electric power grid produces an excess of electricity (i.e., so that the cost of such electricity is reduced), the absorber's electric heating elements may convert electricity from the electric power grid to heat and supply the heat to the TESS 106 for storage and eventual application to the thermal engine 108. Such storage of surplus energy in the form of heat balances loading of the electric power grid so the grid supplies power to system 100 during times when demand is low. When demand from the electric power grid is high, system 100 can disconnect the heating elements from the electrical grid and rely instead on heat that had previously been stored in the TESS 106 by the electric heaters and/or based on current solar collection. Such a grid-balancing solar-thermal system 100 contains a conventional solar-thermal system coupled with electric heaters to store excess electricity to heat.

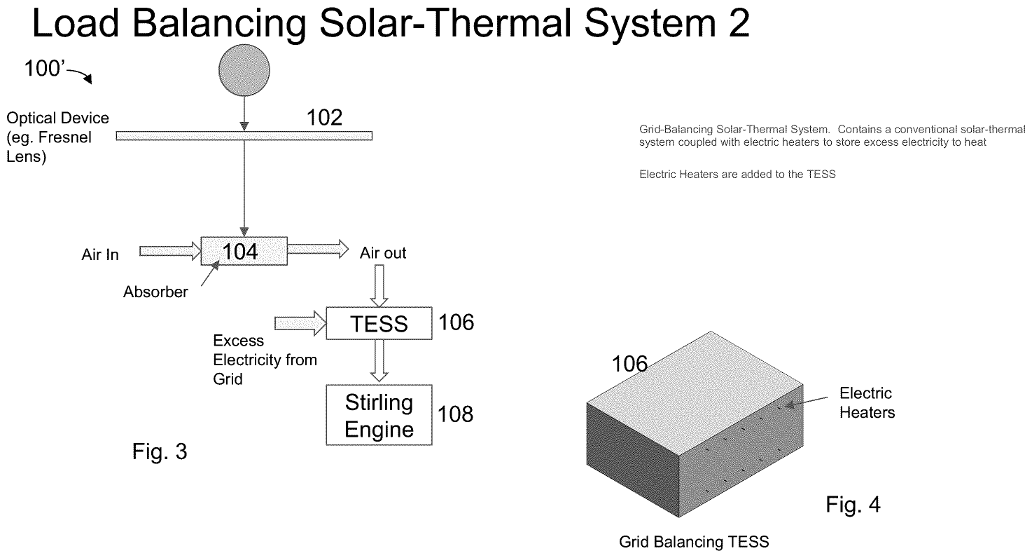

FIGS. 3 and 4 shows a second embodiment of a load balancing solar thermal collection system 100′ where the TESS 106 has electric heating elements to convert electricity from the electric power grid to heat for storing within the TESS. A grid-balancing solar-thermal system thus contains a conventional solar-thermal system coupled with electric heaters in the TESS to store excess electricity to heat.

In one embodiment, an electrical energy monitor (not shown) and an automatic transfer switch can be used to selectively connect the heating elements to the power grid and disconnect the heating elements from the power grid. See e.g., Jiang et al, “Smart grid load balancing techniques via simultaneous switch/tic-line/wire configurations,” 2014 IEEE/ACM International Conference on Computer-Aided Design (ICCAD), San Jose, CA, USA, 2014, pp. 382-388, doi: 10.1109/ICCAD.2014.7001380. Such calculations can be performed by at least one processor connected to non-transitory memory, the processor being configured to execute software instructions and/or perform hardware based algorithms to detect or otherwise determine or predict loading of the power grid.

All patents and publications cited herein are incorporated by reference.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A solar collection system comprising:
at least one solar collector;
at least one thermal storage device; and
an electric heating device optically coupled to the at least one thermal storage device, the electric heating device providing heat for storage by the at least one thermal storage device to balance loading of the electric power grid so the grid supplies power to the electric heating device for heating the at least one thermal storage device 2. during times when demand is low.

2. The solar collection system of claim 1 wherein the electric heating device is thermally coupled to an absorber, and the absorber is optically coupled to the at least one solar collector.

3. The solar collection system of claim 1 further comprising a thermal transfer arrangement configured to transfer, into or out of the at least one thermal storage device, heat collected by the at least one solar collector and/or heat stored by the at least one thermal storage device.
